(19) United States
(12) Patent Application Publication
(10) Pub. No.: US 2016/0056591 A1
(43) Pub. Date: Feb. 25, 2016

(54) ELECTRICAL CONNECTOR HAVING SIDEWARDLY EXPOSED CONTACTS

(71) Applicant: FOXCONN INTERCONNECT TECHNOLOGY LIMITED, Grand Cayman (KY)

(72) Inventors: JUN ZHAO, Kunshan (CN); JING-JIE GUO, Kunshan (CN)

(21) Appl. No.: 14/833,156

(22) Filed: Aug. 24, 2015

(30) Foreign Application Priority Data
Aug. 22, 2014 (CN) 201420476480.4

(51) Int. Cl. H01R 24/58; H01R 12/70

(52) U.S. Cl. CPC H01R 24/58; H01R 12/7076; H01R 2107/00

(57) ABSTRACT

An electrical connector includes: an insulating body having an upper face and a lower face, two opposite side faces, a front face and a rear face, and a plug-receiving hole; and a number of terminals mounted to the insulating body, each terminal having a holding portion, an elastic portion extending into the hole, and an abutment portion. The abutment portion is movably exposed to a corresponding side face.

### BACKGROUND OF THE INVENTION

1. Field of the Invention

The present invention relates to an electrical connector, and more particularly to an audio jack connector mounted in a sinking manner to a printed circuit board and having contacts so structured that a height of the connector relative to the printed circuit board can be adjusted.

2. Description of Related Art

TW 201025760, published on Jul. 1, 2010, discloses an audio jack connector comprising an insulating body and a plurality of terminals fixed to the insulating body. Each terminal includes a resilient mounting portion extending out of a bottom wall of the insulating body for compression contact against a printed circuit board (PCB) on which the audio jack connector is mounted. Such connector is not adapted for sink-type board-mounting where a bottom of the connector is at a height or leveled below a top of the PCB.

US 2015/0050835, published on Feb. 19, 2015, discloses sink-type audio jack connectors meeting market demands of various height specifications. Specifically, a height difference between a center of the connector and a PCB can be changed by employing terminals that have abutment portions of different heights or vertical dimensions.

There is a need for achieving different heights of board-mounted connectors relative to a PCB a new receptacle connector is to solve the above technical problem.

### SUMMARY OF THE INVENTION

An electrical connector includes: an insulating body having an upper face and a lower face, two opposite side faces, a front face and a rear face, and a plug-receiving hole; and a number of terminals mounted to the insulating body, each terminal having a holding portion, an elastic portion extending into the hole, and an abutment portion. The abutment portion is movably exposed to a corresponding side face.

### BRIEF DESCRIPTION OF THE DRAWINGS

FIG. 1 is an assembled perspective view showing an audio jack connector in accordance with the present invention mounted in a sinking manner to a printed circuit board;

FIG. 2 is a bottom perspective view of the audio jack connector in FIG. 1;

FIG. 3 is an exploded view of the audio jack connector; and

FIG. 4 is another bottom perspective view of the audio jack connector.

### DETAILED DESCRIPTION OF THE PREFERRED EMBODIMENT

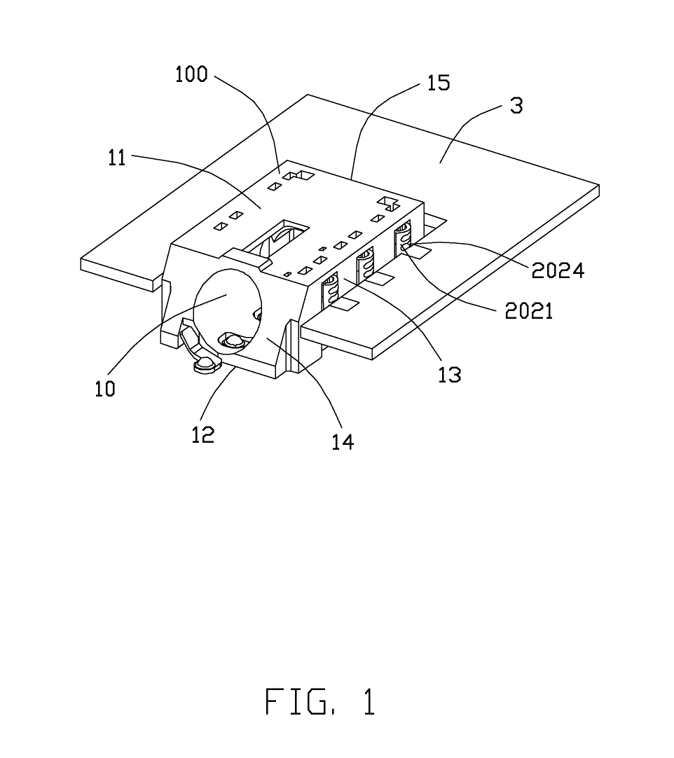

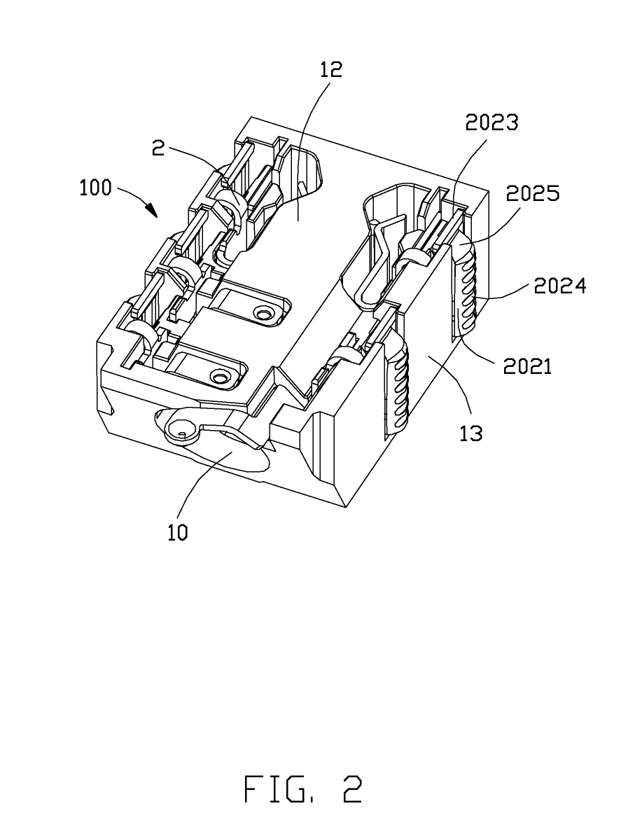

Referring to FIGS. 1-4, an electrical connector 100, an audio jack connector in the embodiment shown, comprises an insulating body 1 having a plug-receiving hole 10 and a plurality of terminals 2 secured to the insulating body. Also disclosed is a printed circuit board (PCB) 3 for mounting the connector 100.

The insulating body is substantially of a rectangular parallelepiped shape and comprises an upper face 11 and a lower face 12, two opposite side faces 13, and a front face 14 and a rear face 15. The plug-receiving hole 10 extends from the front face 14 toward the rear face 15. The insulating body 1 comprises a plurality of terminal receiving grooves 120 exposing to the lower face 12.

Each of the terminal receiving grooves 120 has a retaining portion 1201, an outer portion 1202 outwardly of the retaining portion, and an inner portion 1203 inwardly of the retaining portion. The plug-receiving hole 10 is in fluid communication with the inner portion 1203. The outer portion 1202 has an opening 1200 through the side face 13.

As the embodiment shows, the terminals 2 include a pair of first terminals 21, a pair of second terminals 22, and a third terminal 23.

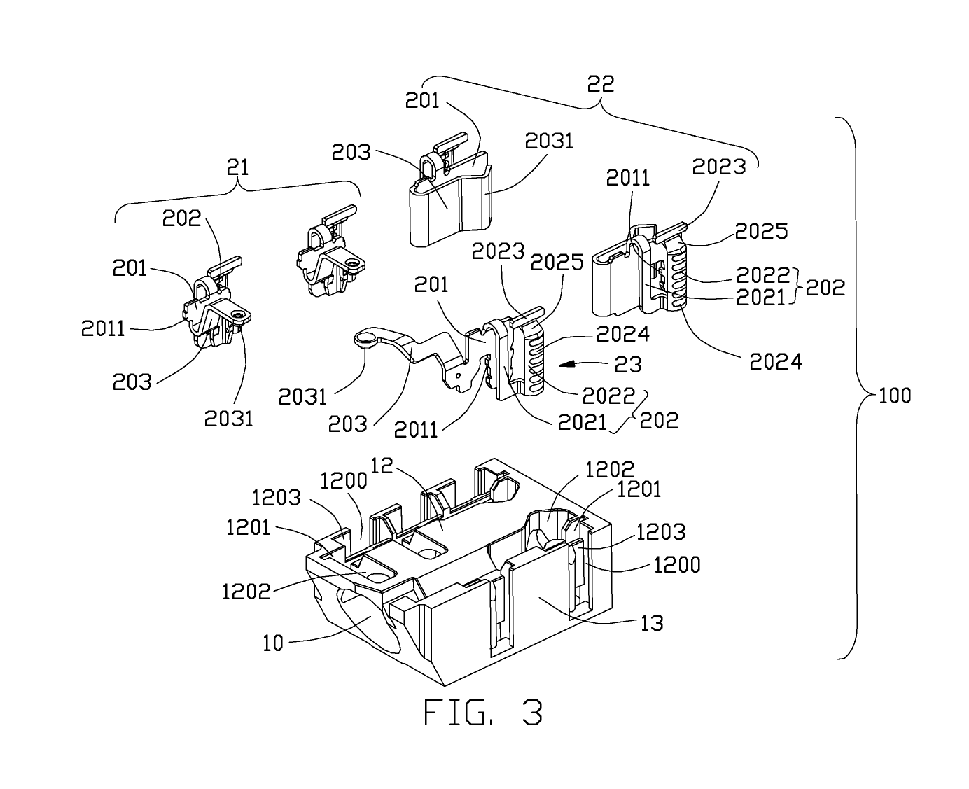

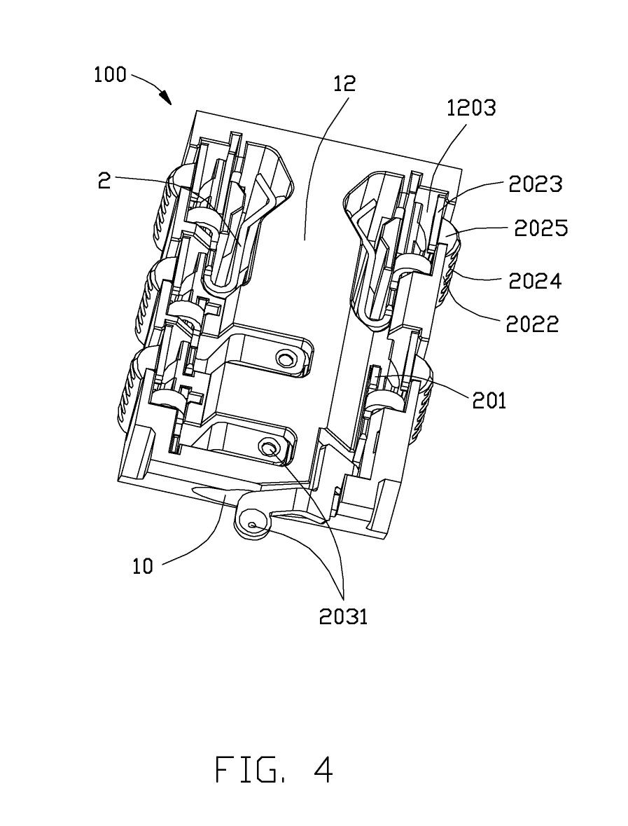

Referring specifically to FIGS. 3 and 4, each terminal comprises a holding portion 201 secured to the retaining portion 1201, an elastic portion 203 extending into the hole 10, and an abutment portion 202 received in the outer portion 1202. The abutment portion 202 and the elastic portion 203 are located on two opposite sides of the holding portion 201. The holding portion 201 has barbs 2011 for interference fit purpose. The abutment portion 202 is movably exposed to a corresponding side face 13 so that it can be pressed by a side edge of a notch (not labeled) formed on the PCB 3 to which the electrical connector 10 is mounted. That is, the abutment portion 202 is elastically deformable in a direction perpendicular to a general plane of the associated side face 13.

The elastic portion 203 of the first terminal 21 is formed by downwardly bending from an upper edge portion of the holding portion 201. The elastic portion 203 of the second terminal 22 is formed by rearwardly bending from a front edge portion of the holding portion 201. The elastic portion 203 of the third terminal 23 is formed by bending and forwardly extending from a front edge portion of the holding portion 201.

Each of the elastic portion 203 of the first terminal 21 and the elastic portion 203 of the third terminal 23 has a contacting portion 2031 in the form of a convex projection. The elastic portion 203 of the second terminal 21 has a contacting portion 2031 in the form of an elongated ridge.

Each of the abutment portions 202 of the first terminal 21, the second terminal 22, and the third terminal 23 is formed by upwardly bending from a lower edge portion of the associated holding portion 201 so that the abutment portion 202 and the holding portion 201 are disposed substantially opposing each other along a sideward direction. The abutment portion 202 includes a pressing portion 2022 and a connecting portion 2021 connected between the pressing portion 2022 and the holding portion 201. The pressing portion 2022 protrudes through the opening 1200 of the side face 13 outwardly of the insulating body 1. Each of the pressing portion 2022 and the connecting portion 2021 extends along a vertical direction. A lower end of the connecting portion 2021 is connected to the holding portion 201, and an upper end of the pressing portion 2022 is connected to an upper end of the connecting portion 2021. The pressing portion 2022 and the connecting portion 2021 are side by side, substantially aligned along an extension direction of the plug-receiving hole 10. The pressing portion 2022 has an inclined surface 2025 at a free end thereof. The pressing portion 2022 also has a plurality of positioning portions 2024 at an exterior side face thereof In the embodiment shown, the positioning portions 2024 are in the form of ridges between consecutive valleys. A vertical distance between two adjacent ridges, i.e., pitch, is less than a thickness of the PCB 3 to ensure proper contact. The abutment portion 2022 thither may be provided with a pre-stress portion 2025. The pre-stress portion 2025 extends across the opening 1200 of the side face 13 and presses against the insulating body 1 to achieve a positive engagement with the PCB notch when the connector 100 is mounted to the PCB 3.

In the embodiment shown, both the connecting portion 2021 and the pressing portion 2022 of the abutment portion 202 can deform resiliently in the width direction of the connector 100, i.e., the direction perpendicular to the side 13. The inclined surface 2025 of the pressing portion 2022 assists in guiding the pressing portion 2022 during mounting the connector 100 to the PCB 3. Understandably, to assure the movement of the connector relative to the PCB 3 in the vertical direction, the PCB 3 may optionally form through holes, and the connector may be optionally equipped with the side posts moveably received. within the corresponding through holes in the vertical direction.

What is claimed is:

1. An electrical connector comprising:
an insulating body having an upper face and a lower face, two opposite side faces, a front face and a rear face, and a plug-receiving hole; and
a plurality of terminals mounted to the insulating body, each terminal comprising a holding portion, an elastic portion extending into the hole, and an abutment portion, the abutment portion being movably exposed to a corresponding side face.

2. The electrical connector according to claim 1, wherein the abutment portion and the holding portion are disposed substantially opposing each other along a sideward direction.

3. The electrical connector according to claim 1, wherein the insulating body comprises a plurality of terminal receiving grooves exposing to the lower face.

4. The electrical connector according to claim 1, wherein the insulating body has a respective opening exposed to a corresponding side face, and the abutment portion includes a pressing portion and a connecting portion between the pressing portion and the holding portion, the pressing portion protruding through the opening outwardly of the insulating body.

5. The electrical connector according to claim 4, wherein each of the pressing portion and the connecting portion extends along a vertical direction, a lower end of the connecting portion is connected to the holding portion, and an upper end of the pressing portion is connected to an upper end of the connecting portion.

6. The electrical connector according to claim 4, wherein the pressing portion and the connecting portion are substantially aligned along an extension direction of the plug-receiving hole.

7. The electrical connector according to claim 4, wherein the pressing portion has an inclined surface at a free end thereof.

8. The electrical connector according to claim 4, wherein the pressing portion has a plurality of positioning portions at an exterior side face thereof.

9. The electrical connector according to claim 1, wherein the abutment portion has a pre-stress portion pressing against the insulating body.

10. An electrical connector for use with a plug, comprising:
an insulative housing defining a pair of outwardly exposed side faces opposite to each other in a transverse direction, and a plug receiving hole extending along a front-to-back direction perpendicular to said transverse direction for receiving the plug;
a plurality of terminals mounted to the housing, each of said terminals defining a contacting section extending into the plug receiving hole for responding to the plug, and an abutment portion exposed upon the corresponding side face and moveable in said transverse direction for mechanical engagement within a notch of a printed circuit board and electrical connection to a corresponding conductive pad around said notch on said printed circuit board.

11. The electrical connector as claimed in claim 10, wherein said contacting section is elastic to be adapted to directly mechanically and electrically connect the plug.

12. The electrical connector as claimed in claim 11, wherein said contacting section is equipped with a horizontal U-shaped structure to provide resiliency thereof in the transverse direction.

13. The electrical connector as claimed in claim 10, wherein said housing further defines an upper face and a lower face opposite to each other in a vertical direction perpendicular to both said transverse direction and said front-to-back direction, and the housing and said terminals are configured to allow said terminals to be assembled into the housing in the vertical direction only.

14. The electrical connector as claimed in claim 13, wherein each of said terminals includes an upstanding U-shaped structure linked between the abutment portion and the contacting section to provide resiliency of said abutment portion in said transverse direction.

15. The electrical connector as claimed in claim 14, wherein each of said terminals further includes for securing to the housing a holding portion associated with the contacting section and commonly located on a same side of said U-shaped structure with the contacting section.

16. The electrical connector as claimed in claim 10, wherein an exterior surface of the abutment portion defines a plurality of positioning portions in a form of ridges between consecutive valleys, and a width of the valley is less than a thickness of the printed circuit board.

17. The electrical connector as claimed in claim 16, wherein the electrical connector is adapted to be retained within the notch at different levels with regard to the printed circuit board via engagement between the printed circuit board and the different ridges.

18. An electrical connector for use with a plug, comprising:
an insulative housing defining a pair of outwardly exposed side faces opposite to each other in a transverse direction, and a plug receiving hole extending along a front-to-back direction perpendicular to said transverse direction for receiving the plug;
a plurality of terminals mounted within the housing, each of said terminals defining a holding section for securing to the housing, and an abutment portion located around the holding portion with an elastic structure therevetween and exposed upon the corresponding side face and moveable in said transverse direction for mechanical engagement within a notch of a printed circuit board and electrical connection to a corresponding conductive pad around said notch on said printed circuit board.

19. The electrical connector as claimed in claim 18, wherein said printed circuit board extends in a plane defined by the transverse direction and said front-to-back direction.

20. The electrical connector as claimed in claim 19, wherein each of said terminals further includes a contacting section located around the plug-receiving hole for electrically responding to insertion of the plug.
